(19) United States
(12) Patent Application Publication
(10) Pub. No.: US 2011/0216547 A1
(43) Pub. Date: Sep. 8, 2011

(54) LIGHTING APPARATUS

(75) Inventors: Yutaka Honda, Yokosuka-Shi (JP); Takayoshi Moriyama, Yokosuka-Shi (JP); Kazunari Higuchi, Yokosuka-Shi (JP); Kenji Nezu, Yokosuka-Shi (JP); Shinichi Kumashiro, Yokosuka-Shi (JP)

(73) Assignees: TOSHIBA LIGHTING & TECHNOLOGY CORPORATION, YOKOSUKA-SHI (JP); KABUSHIKI KAISHA TOSHIBA, TOKYO (JP)

(21) Appl. No.: 13/040,025

(22) Filed: Mar. 3, 2011

(30) Foreign Application Priority Data
Mar. 5, 2010 (JP) P2010-049778
Mar. 5, 2010 (JP) P2010-049779

(51) Int. Cl. F21V 29/00; F21V 15/01

(52) U.S. Cl. 362/373; 362/362

(57) ABSTRACT

In one embodiment, a lighting apparatus includes a base electrically grounded and a substrate provided in the base in which an emitting element is mounted. A transmissive cover is arranged in the front side of the substrate, and a metallic holding element is fixed to the base for supporting a peripheral portion of the cover by pressing the peripheral portion from the front side.

### CROSS-REFERENCE TO RELATED APPLICATION

This application is based upon and claims the benefit of priority from Japanese Patent Applications No. 2010-049778 and No. 2010-049779, respectively filed March 5, 2010, the entire contents of which are incorporated herein by reference.

### FIELD

Embodiment described herein relates generally to a lighting apparatus.

### BACKGROUND

As for light emitting elements, such as LED, the light output falls and life also becomes short as temperature rises. For this reason, in order to extend the life and to improve the lighting characteristics, for example, luminous efficiency for the lighting apparatus equipped with the solid light emitting elements, such as LED and EL element as a light source, it is required to suppress the rising of the temperature of the light emitting element.

### BRIEF DESCRIPTION OF THE DRAWINGS

The accompanying drawings, which are incorporated in and configure a portion of the specification, illustrate embodiments of the invention, and together with the general description given above and the detailed description of the embodiments given below, serve to explain the principles of the invention.

FIG. 1 is an elevational view showing a lighting apparatus according to one embodiment of the present invention.

FIG. 2 is an exploded perspective view of the lighting apparatus shown in FIG. 1. (a light trim member is dismounted)

FIG. 3 is a cross-sectional view showing a light source portion of the lighting apparatus shown in FIG. 1.

FIG. 4 is a perspective diagram showing a reflector, a transmissive cover and a holding element of the light source portion of the lighting apparatus shown in FIG. 1 by exploding.

FIG. 5 is an enlarged perspective diagram showing a fixture in the lighting apparatus shown in FIG. 1 and a portion of radiating fins of a base.

### DETAILED DESCRIPTION OF THE INVENTION

A lighting apparatus according to an exemplary embodiment of the present invention will now be described with reference to the accompanying drawings wherein the same or like reference numerals designate the same or corresponding portions throughout the several views.

In one embodiment, a lighting apparatus includes: a base electrically grounded; a substrate provided in the base and having an emitting element thereon; a transmissive cover arranged in the front side of the substrate; and a metallic holding element fixed to the base for supporting a peripheral portion of the cover by pressing the peripheral portion from the front side of the base, the metallic holding element electrically connected to the base.

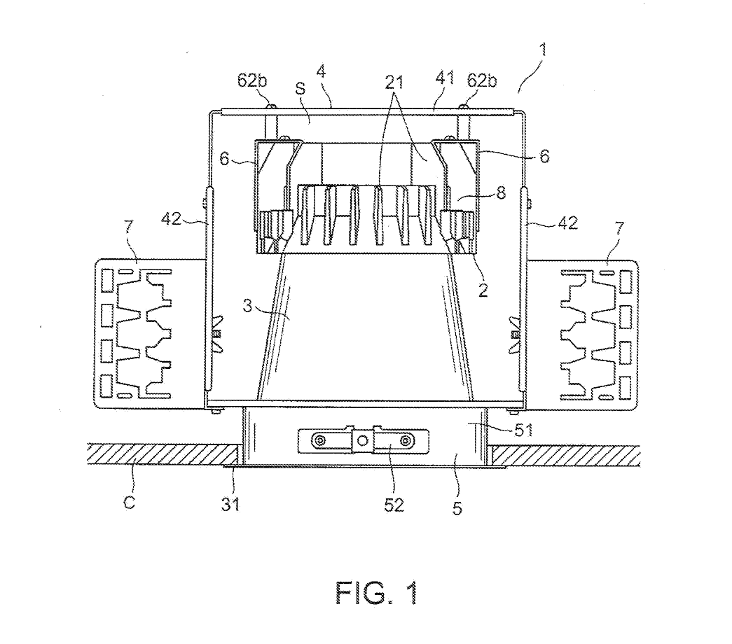

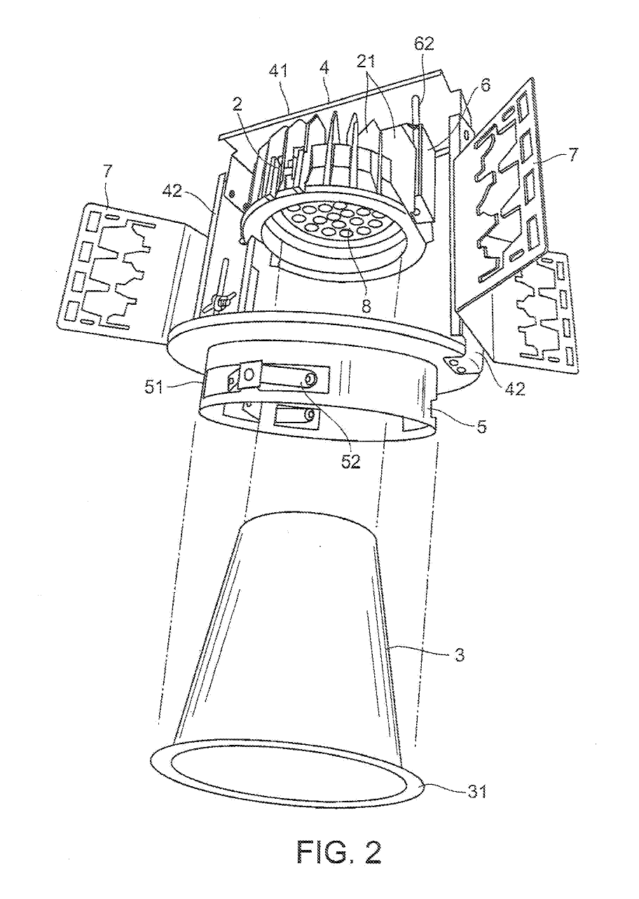

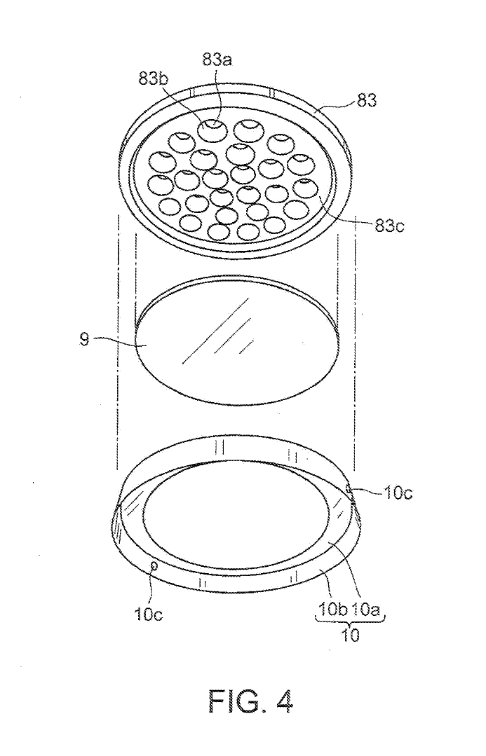

The lighting apparatus according to one embodiment is a down-light 1 of a type embedded in a ceiling C. The down-light 1 is explained with reference to FIG. 1 or FIG. 4. As shown in FIG. 1 and FIG. 2, the down-light 1 is equipped with a base 2 of the lighting apparatus, a light trim member 3, a supporting element 4, a frame 5, a fixture 6, and a power supply unit that is not illustrated. In addition, a fixture element 7 of C channel type fixed to a beam arranged under the roof is provided at the both sides of the supporting element 4.

The base 2 of the apparatus having thermal conductivity is formed approximately in the shape of a cylinder. That is, an inner surface of the base 2 is formed in an expanding shape toward a front side, that is, an irradiating direction with inclination. The base 2 is formed of a heat conductive material, such as aluminium alloy by die-casting. Furthermore, a plurality of radiating fins 21 extending in a perpendicular direction are formed in the perimeter side of the base 2. The light source portion 8 which will be explained later is arranged inside the base 2. In addition, although the base 2 is formed by die-casting made from the aluminium alloy in this embodiment, if the material has thermal conductivity, the material is not limited to special one. Furthermore, the radiating fin 21 is provided to enlarge surface area of the perimeter side of the base 2, and formed so as to project but not limited to the fin shape, a plate shape, an inverted V-shaped and the like.

The light trim member 3 is formed in the shape of a cone expanding to the front side. The light trim member 3 is formed, for example, with metal material, such as aluminum, and its inner surface is configured as a reflective surface. An annular flange 31 extending in the perimeter direction is integrally formed at a circular opening end expanding gradually toward the front side in the light trim member 3. The light trim member is contacted with the metal inner case 11 which will be explained later.

The light trim member 3 configured in this way is arranged so that the light trim member 3 surrounds the circumference of the light source portion 8. The light trim member 3 has a function which carries out distribution control of the light emitted from the light source portion 8 according to the inclined form of the inner surface expanding toward the front side. For example, the light trim member 3 has a function of glare reduction.

The supporting element 4 is provided to attach and support the base 2 of the apparatus under of the roof. The supporting element 4 is formed in the shape of a U-shaped with heat conductive metal material, such as zinc-coated metal plate, and is arranged so that the supporting element 4 surrounds the circumference of the base 2. The supporting element 4 is composed of a top plate 41 arranged at the back side of the base 2, and side plates 42 arranged so that the side plates 42 extend downward in the vertical direction from both sides of the top plate 41. One end side (upper side in figure) of the side plate 42 is attached to the top plate 41, and the other end side (under side in figure) is attached to the frame 5. In addition, the supporting element 4 may not be limited to a frame shape, but also may be a shape to surround the base 2. In short, the support element 4 is equipped to support the base 2.

The frame 5 is formed in the shape of a ring having a cylindrical portion 51. A plate spring 52 in the shape of a butterfly elastically projected to the inner surface of the cylindrical portion 51 is attached to the cylindrical portion 51. Therefore, as shown in FIG. 2, the light trim member 3 penetrates and is inserted in the opening of the frame 5. The light trim member 3 is arranged so as to surround the circumference of the light source portion 8 and is held by the elastic strength of the plate spring 52.

The fixture 6 for fixing the base 2 to the supporting element 4 is formed with metal material with good heat conductivity. One end side of the fixture 6 is attached to the radiating fin 21 of the base 2, and the other end side is attached to the top plate 41 of the supporting element 4. The fixture 6 is formed at two portions facing each other in the perimeter of the base 2. The fixture 6 has both functions for attaching the base 2 to the supporting element 4 and transmitting the heat.

The power supply unit which is not illustrated is equipped with a power supply circuit, a wiring box, and terminals and the like, and is electrically connected with the base 2. Specifically, the power source wire and earth wire for supplying electric power to the light source portion 8 are connected, and the electrical potential of the base 2 is set to ground level.

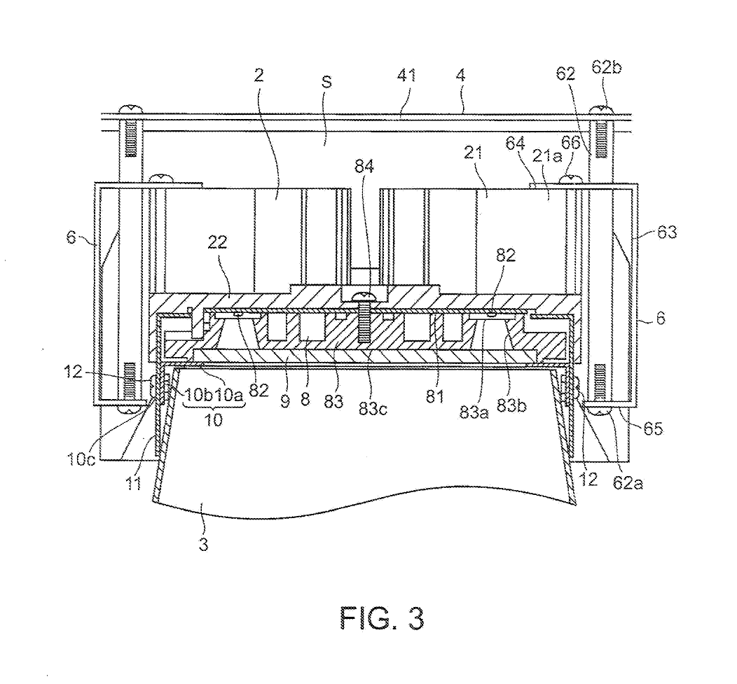

The light source portion 8 is equipped with a substrate 81, light emitting element 82 mounted on the substrate 81, and a reflector 83 as shown in FIG. 3.

The substrate 81 is formed of a plate in the shape of an approximately round shape, and a plurality of light emitting elements 82 used as a light source are mounted on the surface of the substrate 81. The light emitting element 82 is a package type LED, and the LED package is mounted on the substrate 11 by the surface-mount system. Moreover, the package of the LED emits white light by supplying current.

As the substrate 81, in order to improve the heat dissipation characteristics of each light emitting element 82, it is preferable to use metal material having a thermal conductivity and good characteristics in heat dissipation as the base plate, such as aluminum. In this embodiment, a metal base plate formed of aluminum in which an insulating layer is laminated on one surface is used as the substrate 81. In case the base substrate is formed of insulating material, ceramic material or synthetic resin material, such as glass epoxy resin, is used for the material of the base plate.

As the light emitting element 82, solid light emitting elements, such as LED and organic electroluminescence, are used. As for mounting the light emitting element 82 to the substrate 81, it is preferable to use a chip-on-board process, that is, to directly mount the LED chip on the substrate 81 or a surface mount process to mount the LED package on the substrate 81. However, the mounting process is not limited to such specific features. Moreover, there is no special restriction in the number of the light emitting elements 82 to be mounted.

The reflector 83 formed with polycarbonate or Acrylonitrile-Styrene-Acrylate resin, or the like is arranged at the front side, that is, the surface side of the substrate 81. Vapor deposition of aluminum is performed to its surface. Therefore, the reflector 83 has a function to control the distribution of the emitted light from respective light emitting elements 82 individually, and irradiates with the light efficiently.

The reflector 83 is formed in the shape of a disk, and a plurality of openings 83a of the same number as the light emitting elements 82 are formed so as to face each of the light emitting elements 82. A tapered reflective surface 83b is formed inside each opening 83a. The reflective surface 83b expands toward the direction of radiation of the light, and each reflective surface 83b is formed in each opening 83a. The light source portion 8 configured in this way is arranged and attached inside the base 2 with an attachment screw 84 as fastener means. The attachment screw 84 is formed of metal having thermal conductivity.

The reflector 83 reflects the light emitted from the light emitting element 82, and thereby, the distribution of the emitting light can be controlled. The reflector 83 may be formed so as to have one reflective surface 83 for each light emitting element 82, or may be formed so as to reflect whole emitting light from all the LEDs.

In more detail, the inner side of the base 2 is formed in the concave shape, and the base 2 has a heat conduction portion 22 to which a back surface of the substrate 81 is arranged in tight contact. The internal side of the heat conduction portion 22 is formed in a circle having a flat surface. A screw hole is formed in the center of the back side of the reflector 83. The reflector 83 is fixed to the heat conduction portion 22 with the attachment screw 84 penetrated into a screw hole. That is, the attachment screw 84 passes through the screw penetration holes of the heat conduction portion 22 and the substrate 81, and is thrusted into the screw hole of the reflector 83. The clamp strength of the attachment screw 84 works in the direction which pulls the reflector 83 toward the heat conduction portion 22. Therefore, ribs of the back side of the reflector 83 contacts with the surface side of the substrate 81, and comes to apply pressure to the surface side of the substrate 81.

In this case, the substrate 81 is arranged between the inside surface of the heat conduction portion 22 and the back side of the reflector 83. Accordingly, the substrate 81 is held between the inside of the heat conduction portion 22 and the back side of the reflector 83 by fixing the reflector 83 to the heat conduction portion 22. Therefore, fixing means does not act on the substrate 81 directly. As mentioned-above, the light source portion 8 is attached inside the base 2, and the. substrate 81 comes to be thermally connected with the heat conduction portion 22. Note that the state where the light source portion 8 is thermally connected with the base 2, means the state where the substrate 81 equipped with the light emitting element 82 contacts with the base 2, and heat transfer is performed.

Next, as shown in FIG. 3 and FIG. 4, a transmissive cover 9 is arranged at the front side (surface side) of the reflector 83 by being supported and arranged using an annular-shaped holding element 10. The cover 9 is circular and is formed of transparent glass material in this embodiment. In addition, the cover 9 may be also formed with synthetic resin material, such as transparent acrylic resin, and also may be formed so as to have diffusivity.

The holding element 10 is formed of a thin zinc plated metal plate in the shape of an approximately ring having thermal conductivity and electrical conductivity. The holding element 10 is configured by a ring shape holding portion 10a formed so as to have outer diameter slightly larger than that of the reflector 83 and a fixture portion built from the holding portion 10a. Moreover, a screw penetration hole 10c is formed in a position which counters the fixture portion 10b.

The cover 9 is fitted to a fitting concave portion 83c in the shape of a circle formed in the surface side of the reflector 83. The cover 9 fitted to the fitting concave portion 83c is supported by being pressed in the peripheral portion of the cover from the front side using the holding portion 10a of the holding element 10.

The cover 9 is formed with glass material or synthetic resin material, such as acrylic resin in this embodiment. However, other materials can be chosen as long as the material is transmissive.

In addition, an inner case 11 is arranged in the inside of the base 2 by being fixed to the heat conduction portion 22. The inner case 11 is formed approximately in the shape of a cylinder along inner surface of the base 2 using zinc-plated metal plate painted in white color. The above-mentioned holding element 10 is fixed to the inner case 11.

Practically, the holding element 10 is fixed to the internal case 11 by a metal fixing screw 12 as fixture means. The fixing screw 12 penetrates in the screw penetration hole 10c formed in the holding element 10 and the inner case 11 from outside, and is fastened with a nut from the inner side.

Therefore, the cover 9 is supported by the holding element 10 by fixing the holding element 10 to the inner case 11 and the holding element 10 is simultaneously grounded so that the base 2 is in ground potential. Moreover, the inner case 11 contacts with the heat conduction portion 22 of the base 2, and the inner case is in electrically connected state. On the other hand, the holding element 10 is electrically connected with the inner case 11 through the fixing screw 12. Accordingly, the holding element 10 is in ground potential by the earth connection. Therefore, safeness can be secured and also be more raised.

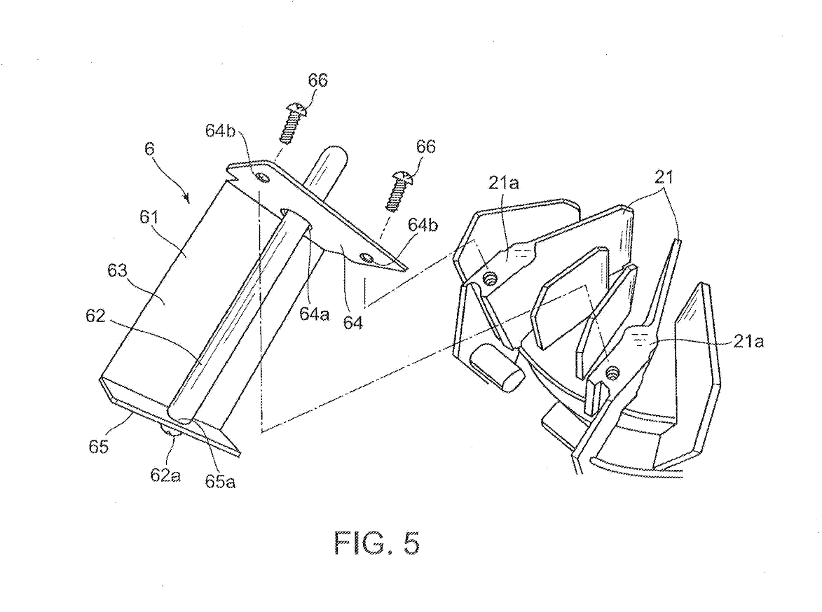

Next, the fixture 6 is composed of a connecting element 61 bended in the shape of a U-shaped and a rod element 62 as shown in FIG. 5. The connecting element 61 is formed of a metal plate, such as zinc-plated metal plate. Furthermore, the connecting element 61 is formed of a rectangular principal surface 63, a contact surface 64 bent from the both sides of the connecting element 61 and a fixing surface 65 for fixing the rod element 62. The contact surface 64 and fixing surface 65 respectively form a contact portion and a fixing portion.

A screw penetration hole 64a in which the rod element 62 penetrates is formed in the contact surface 64 and penetration holes 64b at both sides of the penetration hole 64a in the contact surface 64. A screw penetration hole 65a for fixing the rod element 62 is formed in the fixing surface 65.

The rod element 62 is formed of a brass rod, and screw holes are respectively formed in both ends. The rod element 62 is inserted in the penetration hole 64a of the contact surface 64, and contacts with a portion of the screw penetration hole of the fixing surface 65. The rod element 62 is combined in unit with the connecting element 61 by screwing the bottom side of the fixing surface 65 with a screw 62a from down side (referring to FIG. 5).

The contact surface 64 of the fixture 6 configured in this way is attached to the radiating fin 21 of the base 2 with the attachment screw 66 as fastener means. An installation table 21a slightly broaden in which the screw hole is formed is provided in the upper surface side of the radiating fin 21. The contact surface 64 is laid in this installation table 21a, and the attachment screw 66 which penetrates the screw penetration hole 64b is screwed so as to carry out field contact. Then, the fixture 6 is attached to the radiating fin 21.

On the other hand, as shown in FIG. 1 to FIG. 3, the attachment screw 62b which penetrates the screw penetration hole formed in the top plate 41 of the supporting element 4 is thrusted into the screw hole by the side of the upper end of the rod element 62. Accordingly, the fixture 6 is attached to the supporting element 4. As a result, the fixture 6 connects the radiating fin 21 of the base 2 with the supporting element 4. That is, the base 2 is attached to the supporting element 4 by the fixture 6. In this case, a predetermined space S is formed between the upper surface of the radiating fin 21 of the base 2 and the supporting element 4, that is, a top plate 41 by separating the base 2 and the supporting element 4 by the fixture 6.

Next, the operation of this embodiment is explained. If electric current is supplied to the power supply unit, the light emitting element 82 emits light by supplying electric power to the substrate 81 of the light source portion 8. A plenty of light emitted from each light emitting element 82 penetrates the transmissive cover 9, and is irradiated ahead. Some portion of the emitted light is once reflected by each reflective surface 83b of the reflector 83 corresponding to each light emitting element 82, and distribution control of the reflected light is carried out, and then the light penetrates the cover 9 to irradiate ahead. Then, entire distribution control is carried out by the light trim member 3, and the light is irradiated ahead.

Heat is generated during luminescence of the light emitting element 82. The heat generated in the light emitting element 82 is mainly transmitted from the back side of the substrate 81 to the heat conduction portion 22 of the base 2. The heat is conducted to the direction of the end of the base 2, and even to the end of the base 2 entirely, and the heat is conducted and dissipated at the radiating fin 21.

Moreover, the heat generated in the light emitting element 82 is also dissipated from the front side of the substrate 81. That is, the heat generated in the light emitting element 82 is transmitted from the surface side of the substrate 81 to the reflector 83, and then the cover 9, and is also conducted to the holding member 10 and is radiated. Furthermore, the heat is also conducted from the holding element 10 to the inner case 11, and the heat dissipation is promoted. The deformation of the reflector 83 by the heat from the emitting element is also controlled by heat dissipation from the front side. As mentioned-above, the heat generated in the light emitting element 82 is radiated effectively from the both sides of the back side and the front side of the substrate 81. Moreover, since ground connection is made to the holding element 10, it becomes possible to provide a lighting apparatus which can secure safeness.

Furthermore, the heat conducted to the radiating fin 21 is transmitted from the contact surface 64 of the fixture 6 to the principal surface 63 of the fixing surface 65. Subsequently, the heat is conducted to the supporting element 4 through the rod element 62. Therefore, the heat generated in the light emitting element 82 is also effectively radiated by this conduction path.

According to this embodiment, the radiating fin 21 and the supporting element 4 of the base 2 are connected by the fixture 6 as mentioned-above which attaches the base 2 to the supporting element 4. That is, since heat is transmitted to the supporting element 4 from the radiating fin 21 and the heat dissipation is promoted, the rise in heat of the light emitting element 82 can be suppressed effectively. Furthermore, the heat dissipation of the radiating fin 21 and the supporting element 4 are promoted by the space S between the radiating fin 21 and the supporting element 4.

While certain embodiments have been described, these embodiments have been presented by way of example only, and are not intended to limit the scope of the inventions. In practice, the structural and method elements can be modified without departing from the spirit of the invention. Various embodiments can be made by properly combining the structural and method elements disclosed in the embodiments. For example, some structural and method elements may be omitted from all the structural and method elements disclosed in the embodiments. Furthermore, the structural and method elements in different embodiments may properly be combined. The accompanying claims and their equivalents are intended to cover such forms or modifications as would fall with the scope and spirit of the inventions.

What is claimed is:

1. A lighting apparatus, comprising:
a base electrically grounded;
a substrate provided in the base and having an emitting element thereon;
a transmissive cover arranged in the front side of the substrate; and
a metallic holding element fixed to the base for supporting a peripheral portion of the cover by pressing the peripheral portion from the front side of the base, the metallic holding element electrically connected to the base.

2. The lighting apparatus according to claim 1, wherein the base includes a heat conductive portion, and the substrate is fixed to the heat conductive portion.

3. The lighting apparatus according to claim 2, wherein the metallic holding element is thermally connected with the heat conductive portion.

4. The lighting apparatus according to claim 3, further comprising:
a metal inner case fixed to the metallic holding element and heat conductive portion.

5. The lighting apparatus according to claim 2, wherein the base includes a concave portion formed in an inner side of the base.

6. The lighting apparatus according to claim 4, further comprising:
a light trim member contacted with the metal inner case.

7. The lighting apparatus according to claim 1, wherein the base has a radiating fin provided in an outer surface.

8. The lighting apparatus according to claim 7, further comprising:
a supporting element arranged in a peripheral area of the base to support the base.

9. The lighting apparatus according to claim 8, further comprising:
a fixture for fixing the base to the supporting element by connecting the radiating fin of the base to the supporting element, the fixture conducting the heat generated by the light emitting element from the radiating fin to the supporting element.

10. The lighting apparatus according to claim 9, wherein the fixture includes a U-shaped connecting element and a rod element.

11. The lighting apparatus according to claim 10, wherein the connecting element includes a fixing portion and a contact portion, and one end of the rod element is fixed to the fixing portion and the other end portion is fixed to the supporting element by extending to the supporting element through a penetration hole formed in the contact portion.

12. The lighting apparatus according to claim 11, wherein the radiating fin includes a table facing the supporting element, and the contact portion of the connecting element is fixed to the table.

13. The lighting apparatus according to claim 12, wherein the supporting element and the upper surface of the radiating fin are disposed separately with each other at predetermined distance.
